(19) United States
(12) Patent Application Publication
(10) Pub. No.: US 2003/0069875 A1
(43) Pub. Date: Apr. 10, 2003

(54) Web enabled system for component hardware repair collaboration and material replacement

(76) Inventors: Mark Joseph Rechtsteiner, Cincinnati, OH (US); Christopher Reynolds Hammond, Schenectady, NY (US)

Correspondence Address: GENERAL ELECTRIC COMPANY, ANDREW C HESS, GE AIRCRAFT ENGINES, ONE NEUMANN WAY M/D H17, CINCINNATI, OH, 452156301

(21) Appl. No.: 09/971,892

(22) Filed: Oct. 5, 2001

(51) Int. Cl. G06F 7/00

(52) U.S. Cl. 707/1

(57) ABSTRACT

An internet-based system and method are provided for giving guidance to a user relating to a task, in response to user input data. A dynamic structure asks key questions of the user, then provides guidance in response to the user entered data. This approach provides the logic to link the needs of the user, with the appropriate guided response. With the present invention, dynamic web pages generated by a server side knowledge engine present a series of questions to the user, with guidance generated as the user responds to the questions. The web-based script can then be linked to any html or Java based software to initiate the decision making process.

### BACKGROUND OF THE INVENTION

The present invention relates to a system to track and control programs from initiation to completion.

Currently, many programs within a corporate entity are tracked in individual, unconnected databases, using spreadsheets or other tracking methods. When these programs relate to legal and classified information, proper control is particularly necessary to comply with the law and with company policies, and to minimize legal risks. The lack of an integrated tracking and communication tool can result in miscommunications regarding procedures. This, in turn, can lead to legal risks and lost revenue opportunities.

For example, the control of intellectual property is a critical problem for many corporations, and the problem increases as the size of the intellectual property portfolio increases. With the increasing number of suppliers, joint ventures, and affiliates located throughout the world, control of intellectual property becomes very complex. The problem is particularly acute in departments where the staff is charged with sharing best practices and solving problems. With intellectual property, considerations include whether the intellectual property is proprietary, is a controlled technology within the corporate entity, is export controlled or affected, or is government classified information. Additionally, it must be determined if proprietary information and technology license agreements are in place between the corporate entities sharing the information that covers the specific technology.

It would be desirable to provide a web-based program sharing tool, particularly for the tracking and control of proprietary matters within a group.

### BRIEF DESCRIPTION OF THE INVENTION

A web-based expert system tool is proposed for providing guidance to a user on specific tasks encountered by the user. In particular, the web-based program sharing tool of the present invention can provide immediate feedback and guidance to users on handling requests for the sharing of intellectual and other intangible property.

Accordingly, the present invention provides a tracking and control system that uses dynamic web pages generated by a server side knowledge engine. Key questions are asked of the user, then the system provides guidance in response to the user entered data. This approach provides the logic to link the needs of the user, with the appropriate guided response. With the present invention, a series of questions are presented to the user, with guidance generated as the user responds to the questions. The dynamic system can then be linked to any html or Java based software running on the server to initiate the decision making process.

### BRIEF DESCRIPTION OF THE DRAWINGS

FIG. 1 is a schematic block diagram illustrating a website accessibility structure for the task guidance system and method; and

FIG. 2 is a schematic block diagram illustrating a typical screen display for the tracking and control system of the present invention.

### DETAILED DESCRIPTION OF THE INVENTION

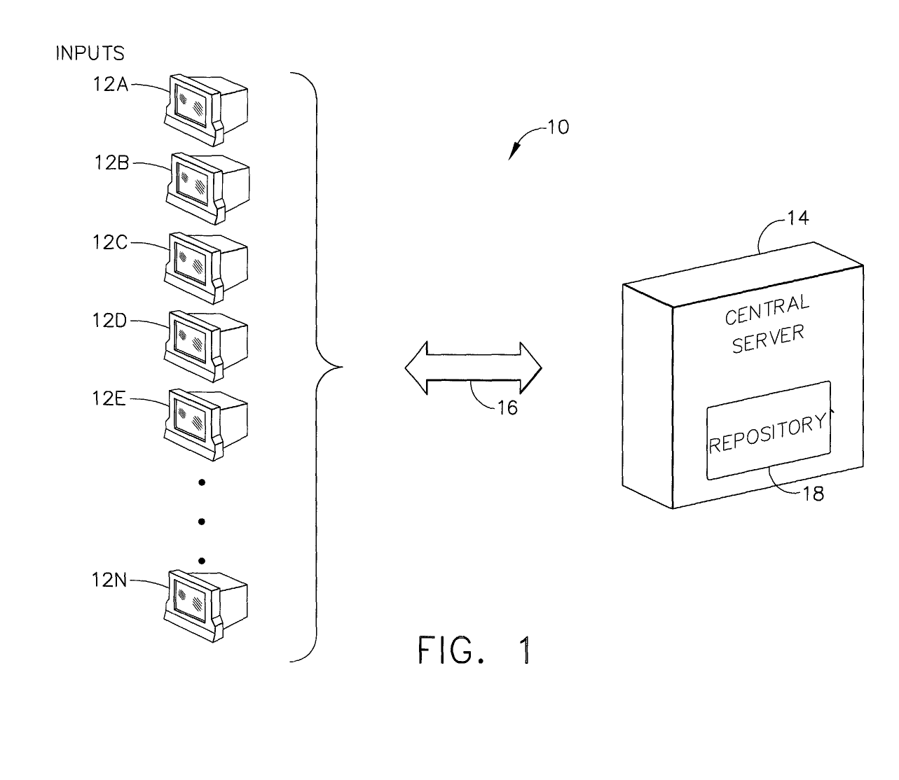

Referring to FIG. 1, there is a schematic block diagram 10 illustrating a repository 18, such as a database or a spreadsheet, for storing accessible details relating to tasks for which a user seeks guidance. The system 10 comprises one or more users 12A-12N. Each user 12A-12N will have access only to its own responses. The responses can be updated online, as the user develops and gains guidance for tasks, such as the sharing or sensitive corporate information.

Continuing with FIG. 1, the structure of the system 10 allows for each user 12A-12N to independently submit a guidance request to a server or central website 14. The server can be configured to store and download text and digital images. In a preferred embodiment, the central website 14 receives data not only from each user 12A-12N, but also from other sources, users, such as links to websites and additional corporate sources.

Continuing with FIG. 1, communication with the central website 14 can comprise any kind of digital communication network or combination of digital communication networks. For example, the communication can be by means of a web browser, local area network (LAN), wide area network (WAN), World Wide Web, or any combination of these networks. Likewise, the users 12A-12N can be of any form so long as the inputting of information, requests for information, and retrieval of information can be communicated between each user 12 and the central website 14.

The central website 14 provides each of the users with an interface 16 that permits the user to convey requests for a recommended procedure or a guidance recommendation. The interface 16 includes an input portion and an output portion. The input portion of the interface is used to convey information from the user to the central website 14. The output portion conveys information from the central website 14 to the user, and is typically displayed on the monitor of the user's computer. However, the output portion is capable of being displayed on other output peripherals, like printers. Typically, the input information is generated by the user's actuation of an input peripheral, such as a mouse or a keyboard.

In the illustrated embodiment of FIG. 1, the interface 16 is provided by web pages that can be transmitted by the central website 14 to each of the users 12A-12N. A web page can include input and/or output portions. The input portion of a web page allows the user to enter information relevant to the task requiring guidance, using an input peripheral, such as a mouse or keyboard. The output portion of a web page is used to provide the user with a guidance recommendation or mandate.

Although the configuration described herein refers to a website 14 being geographically and physically separated from each user link 12A-12N, this does not preclude integrating the website data and information from website 14 into each of the user sites 12A-12N to create a stand-alone system. In such a case, it is feasible to use a network to update the information from website 14 resident in each of the computers 12A-12N. It is also feasible to download the website 14 information and data to the user computer 12A-12N each time guidance is requested from the website 14.

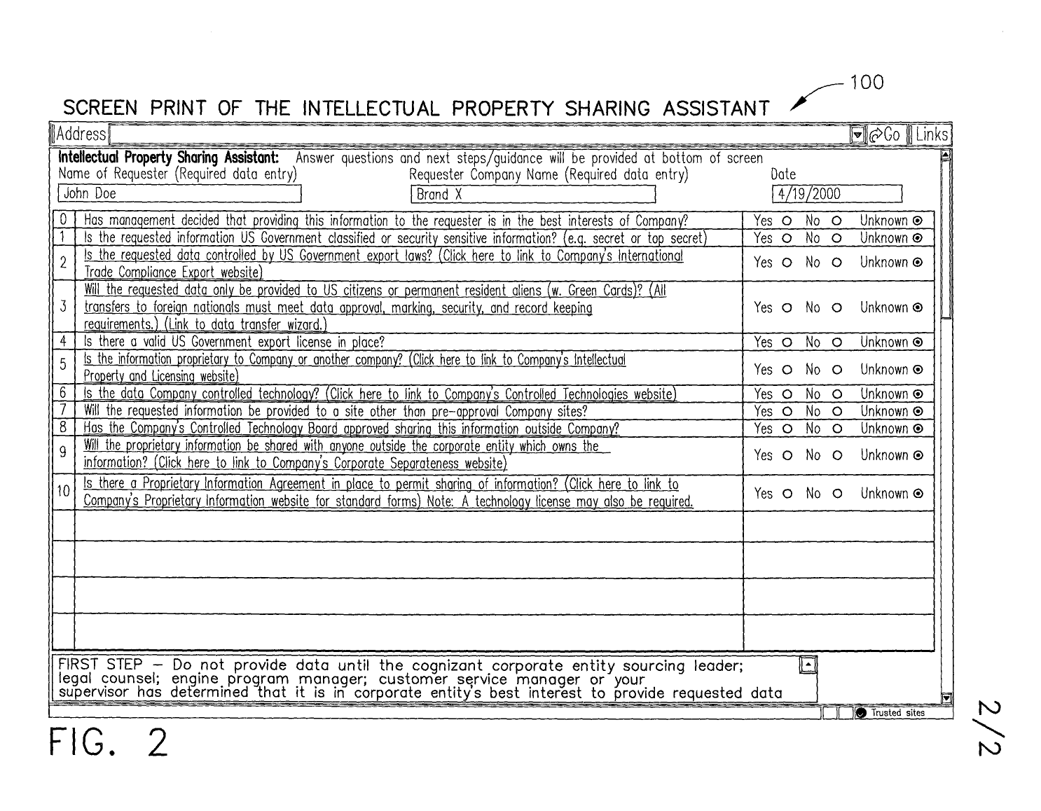

Continuing with FIG. 1, and referring also to FIG. 2, during communication between the website 14 and the user sites 12A-12N, the user answers a series of questions. The series of questions is structured to elicit responses/input by the user to provide program information, and to respond with program guidance for the user. The structure comprises multiple questions requesting a “yes”, “no”, or “unknown” response from the user. The system assists the user in making decisions on a task through the asking of questions directed to the user. The questions and answers are kept current as the user moves through them. The questions and answer choices may be static, or dynamically generated. Questions and answers are dynamically generated by the decision tree that drives the web page, with questions possibly dependent on answers to previous questions. The questions and answers are kept current as the user moves through them. The system also assists the user by providing guidance on how to appropriately respond to the questions presented.

FIG. 2 illustrates an exemplary screen display 100 illustrating an exemplary series of questions. Although the drawing relates to intellectual property areas of concern, this is for purposes of description only, and is not to be considered as limiting the scope of the invention. It will be obvious to those skilled in the art that the web-based tool of the present invention is applicable to assisting a user in making decisions on a task in a variety of environments. Furthermore, the exemplary series of questions can be written using any software application, including but not limited to a spreadsheet application such as Excel.

The exemplary intellectual property sharing assistance program illustrated herein can cover a wide range of intellectual property areas of concern. The expert system asks key questions, for example, questions Q0-Q10 on the display screen 100. Each question elicits a response of “yes”, “no”, or “unknown” from the user. Rather than a flowdown logic arrangement, wherein subsequent questions are based on previous responses, in a preferred embodiment, the responses are taken in their entirety to provide guidance to the user.

In a particularly applicable environment, a user accesses the Intellectual Property Sharing Assistant, to receive guidance on whether certain potentially sensitive company information can be shared with a requester, John Doe, at a requester company, Brand X. The name of the requester is required data, and the name of the requester company is also required data. A data entry can also be made to indicate the date on which the information is requested. From there, the user receives a series of questions, such as questions Q0-Q10, so that the Assistant tool can acquire sufficient information to give guidance to the user.

Following each exemplary question Q0-Q10, the user can respond with a “Yes” or a “No” answer. If the question cannot be answered “Yes” or “No”, the user may input an “Unknown” response. With intellectual property, considerations include whether the intellectual property is proprietary, is a controlled technology within the corporate entity, is export controlled or affected, or is government security, department of defense, or otherwise classified information. Additionally, it must be determined if proprietary information and technology license agreements are in place between the corporate entities sharing the information that covers the specific technology. Exemplary questions Q0-Q10 elicit this information from the user, to determine if it is appropriate for the user to share information with the requester company. Furthermore, guidance information can be embedded within the questions to provide names and contact information of persons with the legal, technical and corporate information necessary to be able to provide additional guidance or information to the user. Links can also be provided relevant to certain of the questions, to assist the user in responding to the question.

After the user answers the questions, various options are possible, depending on the needs of the user. For example, the screen can simply display a statement or series of steps that the user should follow, based on the answers, as compared to corporate policies and legal restrictions. Alternatively, the user may be linked to accessible software to initiate the decision making process. The user may also be given an opportunity to access other sites linked to the sharing assistant of the present invention, such as sample agreements or other databases of information. Finally, emails or other communications relating to the questions, answers, and/or decision, can be automatically generated to supervisory personnel, legal counsel, program managers, and/or other interested parties.

The business application developed herein allows users to receive immediate online guidance relating to a task in a variety of environments, such as the sharing of intellectual and other intangible property. With the control of intellectual property being of particular concern to companies, an “expert” system such as is disclosed herein, can provide consistent guidance in response to user entered data. The user can access the web tool to increase productivity, and to decrease legal risks and lost revenue opportunities.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A system for providing guidance to a user in response to user entered data, the system comprising:
a server configured with a repository of task guidance questions and answer choices, said server capable of receiving information input from a user into the repository for upload to said server including responses to the questions, and allowing a user to download information from the repository including guidance on acceptable procedures responsive to the information input from the user;
at least one computer; and
an interface between the at least one computer and the server.

2. A system as claimed in claim 1 wherein access to said server is configured to be secured by user password.

3. A system as claimed in claim 1 wherein the task guidance questions and answer choices comprise intellectual property sharing task guidance.

4. A system as claimed in claim 1 wherein said user comprises multiple users.

5. A system as claimed in claim 4 wherein the repository is owned by an owner entity.

6. A system as claimed in claim 5 wherein the multiple users comprise users internal to the owner entity.

7. A system as claimed in claim 1 wherein the interface is provided by web pages that can be transmitted from the repository to the user.

8. A system as claimed in claim 8 wherein said server is configured to provide the user with links to web pages.

9. A system as claimed in claim 1 wherein said server is configured to store and download text and digital images.

10. A system as claimed in claim 1 wherein the repository comprises a database.

11. A system as claimed in claim 10 wherein the repository comprises a spreadsheet.

12. A method for providing guidance to a user in response to user entered data, the method comprising the steps of:
uploading user information to a server;
downloading from the server, web pages configured to direct a user to a repository within the server, the repository configured with task guidance questions and answer choices;
uploading user responses input into the web pages to the server; and
downloading from the server guidance on acceptable procedures responsive to the information input from the user.

13. A method as claimed in claim 12 further comprising the step of configuring the server to be secured by user password.

14. A method as claimed in claim 12 wherein the task guidance questions and answer choices comprise intellectual property sharing task guidance.

15. A method as claimed in claim 12 wherein said user comprises multiple users.

16. A method as claimed in claim 12 further comprising the step of configuring the server to store and download text and digital images.

17. A method as claimed in claim 12 wherein the repository comprises a database.

18. A method as claimed in claim 12 wherein the repository comprises a spreadsheet.
